(19) United States
(12) Patent Application Publication
(10) Pub. No.: US 2025/0035211 A1
(43) Pub. Date: Jan. 30, 2025

(54) SEAL FOR A DOUBLE-RAIL CONDUCTOR ASSEMBLY

(71) Applicant: Lisa Dräxlmaier GmbH, Vilsbiburg (DE)

(72) Inventors: Stefan WIMMER, Hohenthann (DE); Johannes TAUSCH, Pfaffenhofen a.d. Ilm (DE)

(73) Assignee: Lisa Dräxlmaier GmbH, Vilsbiburg (DE)

(21) Appl. No.: 18/913,513

(22) Filed: Oct. 11, 2024

Related U.S. Application Data
(63) Continuation of application No. PCT/EP2023/057584, filed on Mar. 24, 2023.

(30) Foreign Application Priority Data
Apr. 14, 2022 (DE) 10 2022 109 354.9

(51) Int. Cl. F16J 15/10; B60R 16/02; H02G 5/00

(52) U.S. Cl. CPC F16J 15/104; H02G 5/00; B60R 16/0207

(57) ABSTRACT

A seal for a double-rail conductor assembly includes a seal carrier with two seal carrier components. The two seal carrier components are complementary to one another, can be affixed to one another and each exhibit essentially an E-shape. The two seal carrier components form a first receiving space for a first rail-shaped conductor between a first outer leg and a middle section and form a second receiving space for a second rail-shaped conductor between a second outer leg and the middle section. The seal includes a conductor-side sealing element with two seal carrier components which are complementary to one another, which are formed on an inner side of the respective seal carrier component on the inner side which faces the first and second receiving space in order to be brought into contact with the first and second rail-shaped conductor. Additionally, a double-rail conductor assembly with such a seal is provided.

### CROSS-REFERENCE TO RELATED APPLICATIONS

This application is a continuation of International Application No. PCT/EP2023/057584, filed on Mar. 24, 2023, which claims priority to and the benefit of DE 10 2022 109 354.9 filed on Apr. 14, 2022. The disclosures of the above applications are incorporated herein by reference.

### FIELD

The present disclosure relates to a seal for a double-rail conductor assembly and a double-rail conductor assembly with such a seal.

### BACKGROUND

The statements in this section merely provide background information related to the present disclosure and may not constitute prior art.

For example, in automotive technology rail-like conductors which typically feature a rectangular cross-section and extend longitudinally are used as electrical conductors to supply components of the electrical system with electricity or energy. An assembly with two rail-like conductors, that is to say a double-rail conductor assembly, can also be used for this purpose, in which a first rail-like conductor constitutes a supply line and a second rail-like conductor constitutes a ground line. Typically, a rail-like conductor or a double-rail conductor assembly such as this should be sealed against environmental influences, such as water entry for example. This is more difficult, however, when a double-rail conductor assembly is used, because there is no appropriate seal known for this purpose.

### SUMMARY

This section provides a general summary of the disclosure and is not a comprehensive disclosure of its full scope or all of its features.

The present disclosure provides a seal for a double-rail conductor assembly using the simplest constructive means possible. A double-rail conductor assembly which is sealed in this way can be employed, for example, in an electrical system, a charging system, a traction path, or the like in a vehicle, a motor vehicle, etc.

A seal for a double-rail conductor assembly is provided. The seal features a seal carrier with two seal carrier components which are complementary to one another and can be affixed to one another, which each exhibit essentially an E-shape and form a first receiving space for a first rail-shaped conductor between a first outer leg and a middle section and form a second receiving space for a second rail-shaped conductor between a second outer leg and a middle section. Additionally, the seal features a sealing element on the conductor side with two seal carrier components which are complementary to one another which are formed on an inner side of the respective seal carrier component which faces the first and second receiving space, in order that the sealing element may be brought into contact with the first and second rail-shaped conductor.

With this seal, two rail-shaped conductors running parallel to one another, that is to say a double-rail conductor assembly, can be sealed, in particular all the way to interfaces, such as for example a housing, a conductor feedthrough, or the like. Due to the two-component design of the seal carrier and/or of the conductor-side sealing element, the seal can be affixed to the rail-shaped conductors very simply from a sideways direction with respect to the longitudinal direction of the double-rail conductor assembly, which enables easy assembly.

As used herein, a double-rail conductor assembly features the first and second rail-shaped conductors, which are arranged parallel to one another with their flat sides facing one another. In other words, both of the rail-shaped conductors can be arranged on top of one another with respect to a carrier structure, such as a part of a vehicle chassis or the like, with their flat sides facing one another. One of the rail-shaped conductors can constitute a supply line and the other rail-shaped conductor can constitute a ground line. The first and the second rail-shaped conductors can be provided with an insulation jacket, around which the seal provided here is mounted. Preferably the first and second rail-shaped conductors are spaced apart from one another in the area of the seal.

The seal carrier is a structurally significant component, which can also be designated as a hard component. It can, for example, be constructed from a suitable plastic material, for example by means of injection molding or a similar process, wherein the plastic material can be, for example, a thermoplastic. The seal carrier itself can still contribute to the sealing action despite its hardness and/or stiffness, in that it features a profile or other surface structure on its outer side, for example. In contrast, the conductor-side sealing element, just like every other sealing element described here, is primarily configured to have a sealing effect and is therefore preferably made of a material that is softer and/or more elastic plastic than the plastic of the seal carrier, such as a thermoplastic elastomer or a comparable material. Sealing lips or an equivalent structure can be provided on the sealing element.

The mutually complementary design of the seal carrier components and/or the conductor-side seal carrier components can subsequently be understood to complete one another in their state of being assembled or affixed to one another as the seal carrier or rather the sealing element, and together they form this. Both the seal carrier components as well as the sealing element components can respectively be identical parts, which are preferably assembled in a mirrored fashion.

The seal can be a so-called 2C part, which is made, for example, by means of a 2-component injection molding process. Correspondingly, “forming” can be understood to mean that two different materials, namely that of the seal carrier and that of the conductor-side or of a housing-side sealing element, are combined with one another and stick together or are fastened together in one shape or another.

According to a further development, the two seal carrier components, that is to say the first and second seal carrier component, feature a snap-together mechanism which is mutually complementary, via which they can be affixed to one another. For example, the first seal carrier component can feature a first component of the snap-together mechanism and the other seal carrier component can feature a second component of the snap-together mechanism which is complementary. This offers the advantage that the seal can be affixed to the double-rail conductor assembly with nothing more than a snapping action, which can even be performed without tools. If desired, the tension can also be released again without damage.

In a further development, the snap-together mechanism on a seal carrier component can feature a latch plate with a locking catch, and the other seal carrier component can feature a latch sleeve with a detent to be engaged with the locking catch. The combination of latch plate and latch sleeve enables a simple union of the two seal carrier components with one another and an easy snapping together of the two.

According to a further development, at least one circumferential channel can be provided in the seal carrier, which is configured to receive a sealing compound and/or the injection molding compound. “Circumferential” can hereby be understood to mean that the channel follows the E-shape of the seal carrier, wherein the channel can be provided on an outer side as well as an inner side of the seal carrier. The channel is preferably in the form of a groove. The channel can extend along a circumferential direction of the seal carrier, which is perpendicular to a longitudinal extent of the first and second rail-shaped conductors. The channel does not have to be filled with a sealing compound or injection molding compound, but can, however, be provided such that the same component is usable for multiple sealing standards or sealing ratings. If, however, a high-level seal is desired, then the sealing compound and/or injection molding compound can be introduced to the channel, preferably after the mounting of the seal to the double-rail conductor assembly.

In a further development, the channel can extend perpendicularly to a longitudinal extension direction of the first and second rail-shaped conductors, and a housing-side sealing element can be formed on the seal carrier, which is configured to seal the channel on the side, that is to say up to or along the longitudinal extension direction of the first and second rail-shaped conductors. This allows for a high degree of sealing to be achieved.

According to a further development, if the channel is located on the inner side of the seal carrier or the seal carrier component, then it can also seal in the direction of or along the longitudinal extension direction of the first and second rail-shaped connectors using the conductor-side sealing element described above. This allows for a high degree of sealing to be achieved.

In a further development, a first circumferential channel can be formed in the seal carrier along an outer circumferential surface and a second circumferential channel can be formed along an inner circumferential surface. As described above, each of the two channels can be sealed using the sealing elements described above, in particular on the sides with respect to the direction in which the channel extends. This also allows high sealing ratings, or rather high-level sealing standards, to be fulfilled.

According to a further development, a strain relief feature can be formed on an inner side of the respective seal carrier component which faces the first and second receiving space, which is configured to exert a pressing force onto a surface of the first and/or second rail-shaped conductor. For example, the strain relief feature can be provided as tabs which extend into the respective receiving space, in particular spring tabs, which are configured to exert a compressing and/or pressing force against the respective rail-shaped conductor. The tabs can be molded on one end of the seal carrier component and come into contact with the rail-shaped conductor with a free end. The tabs can thus be formed such that they engage into the insulation jacket of the respective rail-shaped conductor with a catch, a hook, or similar feature. A high degree of mechanical resistance of the double-rail conductor assembly or rather the seal can be achieved through the use of the strain relief feature.

In a further development, the seal carrier can be composed of a harder and/or stiffer plastic than the conductor-side sealing element. For example, the seal carrier can be made of an injection-moldable thermoplastic or similar material and the conductor-side sealing element, as well as the housing-side sealing element, can be made of a thermoplastic elastomer. The seal thereby exhibits on the one hand a high mechanical resistance and on the other hand a high level of sealing effect.

According to a further development, the seal can furthermore feature a housing, which is configured to house the seal carrier and the conductor-side sealing element. In other words, both the housing can preferably completely surround both the seal carrier as well as the conductor-side sealing element on its inner side, and optionally the housing-side sealing element as well. With this protective housing, the double-rail conductor assembly can be used in a variety of applications, such as for example in a vehicle or motor vehicle.

Additionally, a double-rail conductor assembly is suggested. This can be used, for example, in the electrical supply system of a vehicle, such as for example a motor vehicle. The double-rail conductor assembly features a first rail-shaped conductor, a second rail-shaped conductor, and a seal in one or more of the previously described variants. Two seal carrier components and two sealing element components of the seal are thereby brought together around the first and second rail-shaped conductors from a sideways direction with respect to a longitudinal extension direction of the first rail-shaped conductor and the second rail-shaped conductor which runs parallel to the first.

The double-rail conductor assembly exhibits a high level of sealing ability, wherein the seal carrier components of the seal provide structural integrity and the sealing element components of the seal effect the high level of sealing. The fact that the seal carrier as well as the conductor-side sealing element are provided as two components, the seal is especially simple to affix to the double-rail conductor assembly. One of the rail-shaped conductors can constitute a supply line and the other rail-shaped conductor can constitute a ground line. The rail-shaped conductors can each respectively be provided with an insulation jacket. The variants described above allow the advantages described above to be achieved.

The present disclosure also relates to a vehicle with the double-rail conductor assembly or rather to the use of such a double-rail conductor assembly in a vehicle, such as a motor vehicle. There the double-rail conductor assembly can be used in an electrical supply system of the vehicle, wherein one of the rail-shaped conductors constitutes a supply line and the other rail-shaped conductor constitutes a ground line.

Additionally, the present disclosure relates to a production process for a seal and/or for a double-rail conductor assembly with a seal as described above. In the process, the seal carrier and the conductor-side sealing element are produced by means of a multi-component injection molding process according to one or more of the previously described variants. This seal can be easily affixed to the double-rail conductor assembly from a sideways direction. Optionally, a channel of the seal carrier can be filled with a sealing compound and/or an injection molding compound.

Additional features, advantages, and application possibilities of the present disclosure arise from the following description of advantageous examples and the accompanying figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a double-rail conductor assembly with a seal (without housing) affixed thereto according to one example of the present disclosure;

FIG. 2 is a perspective view of a double-rail conductor assembly with one component or rather one half of a seal (without housing) affixed thereto according to one example of the present disclosure;

FIG. 3 is an exploded view of a component or rather of a half of a seal for a double-rail conductor assembly according to one example of the present disclosure;

FIG. 4 is a perspective view of a double-rail conductor assembly with a seal (with housing) affixed thereto according to one example of the present disclosure; and

FIG. 5 is a sectional view of a double-rail conductor assembly with a seal (with housing) affixed thereto according to FIG. 4.

The figures are only schematic depictions and only serve to illustrate the present disclosure. Identical elements or elements of identical function are always marked with the same reference numbers.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

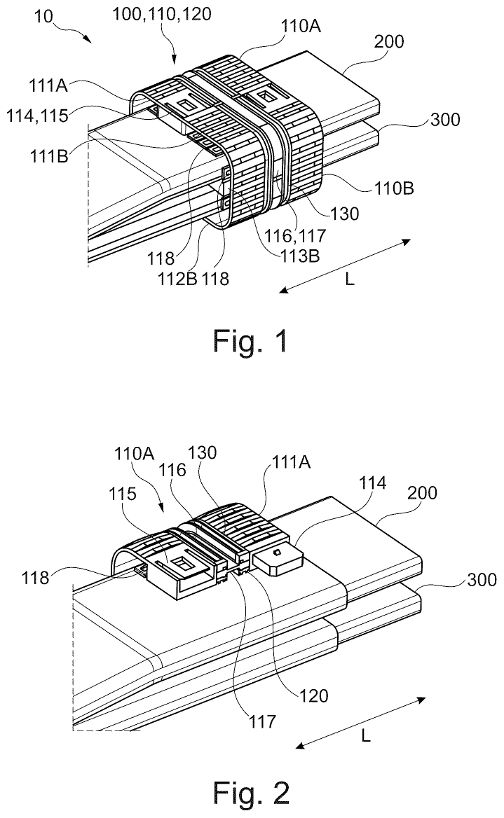

FIG. 1 shows a perspective view of a double-rail conductor assembly 10, which can be used in, for example, an electrical supply system of a vehicle, such as for example a motor vehicle. The double-rail conductor assembly 10 features a seal 100 which surrounds a first rail-shaped conductor 200 and a second rail-shaped conductor 300. Correspondingly, two individual electrical conductors in the form of power rails run parallel and may be spaced apart from one another in the double-rail conductor assembly 10 such that their flat sides face one another or rather run parallel to one another. One of the first and second rail-shaped conductors 200, 300 can thereby be used as a supply line and the other can be used as a ground line. Preferably both the first and second rail-shaped conductors 200, 300 feature an insulation jacket.

As can be seen in FIG. 1, the seal 100 features a seal carrier 110, which is composed of two seal carrier components 110A, 110B, which can be halves, which are complementary to one another; that is to say they complete one another to form the seal carrier, and can be affixed to one another. For example, the seal carrier components 110A and 110B can be identical parts. The seal carrier components 110A, 110B each are essentially E-shaped and form a first receiving space for the first rail-shaped conductor between a first outer leg 111A, 111B and a middle section 113A, 113B and form a second receiving space for a second rail-shaped conductor between a second outer leg 112A, 112B and the middle section 113A, 113B. Optionally, the seal carrier components 110A, 110B can feature a surface feature on their outer side as is indicated in FIG. 1. This surface structure can also be made of a plastic which is different to an additional (first) plastic, wherein the surface structure is preferably softer and/or more elastic than the additional (first) plastic of the seal carrier component 110A, 110B.

According to FIG. 1, the two seal carrier components 110A, 110B feature a snap-together mechanism including a latch plate 114 and a latch sleeve 115 which is mutually complementary, via which they can be fastened together. For example, the seal carrier 110 features a latch plate 114 with a locking catch on one of the seal carrier components and a latch sleeve 115 with a detent on the other seal carrier component to be brought into engagement with the locking catch. It is noted that, when the components are identical, both seal carrier components 110A, 110B each feature a latch plate 114 and a latch sleeve 115.

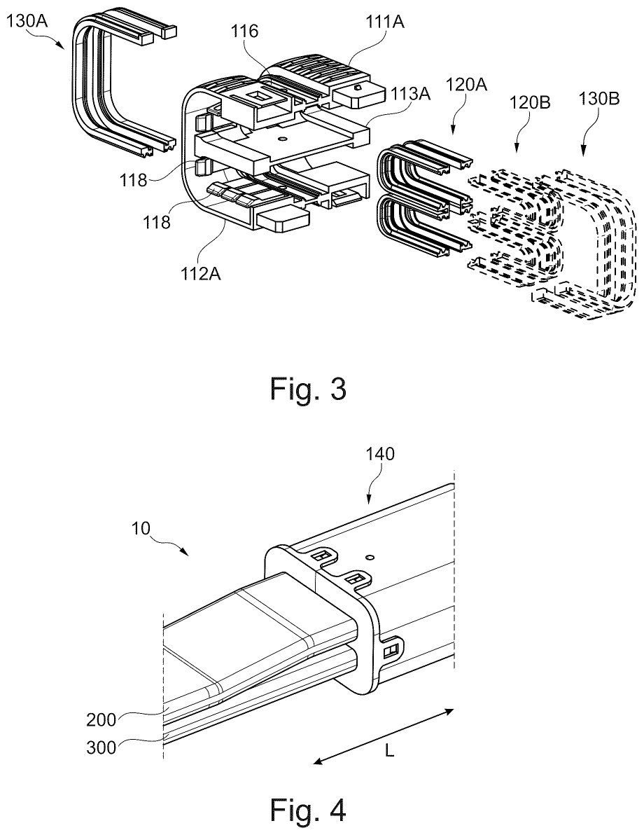

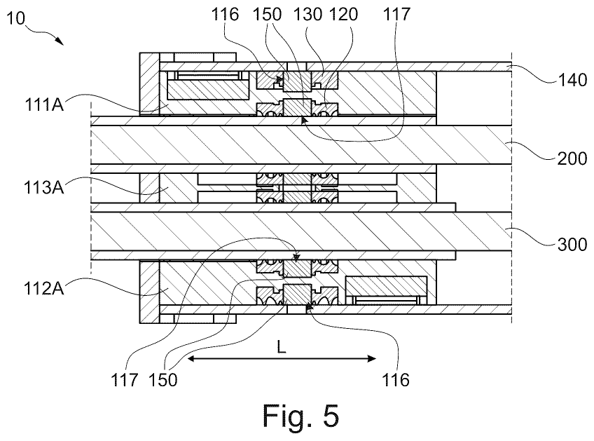

Although covered in FIG. 1 but recognizable in FIG. 1, FIG. 3, and FIG. 5, the seal 100 also features a conductor-side sealing element 120 and optionally a housing-side sealing element 130. Similar to the seal carrier 110, the conductor-side sealing element 120 and the optional housing-side sealing element 130 feature two sealing element components 120A, 120B, or rather 130A, 130B, which are complementary to one another such that together they complete the respective sealing element. The two seal carrier components 120A, 120B or rather 130A, 130B, which are formed on one inner side of the respective seal carrier component 110A, 110B facing the first and second receiving space, can be brought into contact with the first and second rail-shaped conductor 200, 300.

According to FIG. 1, the seal 100 features a first circumferential channel 116 in or on the seal carrier 110 and, optionally, a second circumferential channel 117. The second channel 117 is located on an inner side of the seal carrier 110 and is thus covered in FIG. 1, however recognizable in FIG. 2, FIG. 3, and FIG. 5. The channel 116, 117 runs perpendicular to a longitudinal extension direction L of the double-rail conductor assembly 10 or rather the rail-shaped conductors 200, 300. The channel 116, 117 is configured to receive an injection molding compound and/or a sealing compound in order to achieve a sealing effect in the direction of the longitudinal extension direction L. Preferably the channel 116, 117 is provided in the form of a groove, wherein both seal carrier components 110A, 110B complete one another, so that a circumferential channel 116, 117 is formed around the double-rail conductor assembly 10.

Furthermore, according to FIG. 1 the seal 100 features a strain relief feature 118 on an inner side of the respective seal carrier components 110A, 110B which faces the first and second receiving space, wherein the strain relief feature is formed on the seal carrier component 110A, 110B. The strain relief feature 118 is configured to exert a pressing force on a surface of the first and/or second rail-shaped conductor. For example, the strain relief feature 118 can be provided as tabs which extend into the respective receiving space, in particular spring tabs, which are configured to exert a compressing and/or pressing force against the respective rail-shaped conductor. The tabs can be molded on one end of the seal carrier component 110A, 110B and come into contact with the respective rail-shaped conductor 200, 300 with a free end. The tabs can thus be formed such that they engage into the insulation jacket of the respective rail-shaped conductor 200, 300 with a catch, a hook, or similar feature.

It is noted that the seal 100 can be produced, for example, with a multi-component injection molding process, in which the seal carrier 110 is made of a first plastic material and the sealing element 120, 130 can be made of a second plastic material which is different from the first plastic material. The first plastic material preferably features a higher degree of hardness and/or stiffness than the second plastic material, which is softer and/or more elastic than the first plastic material.

FIG. 2 shows a perspective view of a double-rail conductor assembly 10 with only one component, or rather one half, of the seal carrier 110 described above, here in the example the seal carrier component 110A. It is also noted that the seal carrier component 110B can also be configured identically to this. In FIG. 2 elements or rather features which are at least partially covered in FIG. 1 are now visible. Thus FIG. 2 shows the second channel 117 which is on the inside with respect to the seal carrier 110, and which extends parallel to the outside first channel 116, perpendicular to the longitudinal extension direction L of the double-rail conductor assembly 10. Additionally, FIG. 2 also shows the conductor-side sealing element 120 which is on the inside with respect to the seal carrier 110, and which seals the inside second channel 117 in the longitudinal extension direction L.

FIG. 3 shows an exploded diagram of only one part, or rather one half, of the seal 100, here in the example of the seal carrier component 110A. In FIG. 3, the E-shape of the seal carrier component 110A described above is recognizable, with the first outer leg 111A, the second outer leg 112A, and the middle section 113, which can also be designated as a sort of middle web. Additionally, the strain relief feature 118 or rather its tabs, which are coupled with the seal carrier component 110A on one side, are visible in detail, wherein in FIG. 3 only two exemplary tabs are shown for greater clarity. It is recognizable that the conductor-side sealing element 120 also features a corresponding E-shape.

FIG. 4 shows a perspective view of the double-rail conductor assembly 10 from FIG. 1 with a housing 140, which is arranged around the seal carrier 110, the conductor-side sealing element 120, and optionally the housing-side sealing element 130. For example, the housing 140 is provided as multiple components, wherein the multiple components can be snapped together with one another in order to retain the housing 140 on the double-rail conductor assembly 10.

FIG. 5 shows a sectional view of the double-rail conductor assembly 10 from FIG. 4. Here, both channels 116, 117 are filled with an injection molding compound 150 and/or a sealing compound. It is noted that, in accordance with sealing standards or sealing rating, it is also possible that neither or only one of the channels 116, 117 can be filled with the injection molding compound 150 and/or the sealing compound.

In summary, the seal 100 features halves which are held together via a snap-together mechanism or clip-together mechanism. Both halves can respectively be slid over both rail-shaped conductors 200, 300, which can also be designated as flat conductors. Sealing lips attached to the seal carrier 110, that is to say the conductor-side sealing element 120, the housing-side sealing element 130, and/or optionally the surface structure with a sealing effect, thereby close a transition between the seal 100, an interface, and the rail-shaped conductors 200, 300. Optionally, the injection molding compound 150 can be introduced to at least one of the channels 116, 117. This creates the possibility of satisfying various sealing standards (IP ratings).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A seal for a double-rail conductor assembly, comprising:
a seal carrier with two seal carrier components which are complementary to one another and are configured to be fastened to one another, each of the two seal carrier components is E-shaped and forms a first receiving space for a first rail-shaped conductor between a first outer leg and a middle section, and forms a second receiving space for a second rail-shaped conductor between a second outer leg and the middle section; and
a conductor-side sealing element with two conductor-side seal carrier components which are formed on one inner side of a respective seal carrier component of the seal carrier facing the first receiving space and the second receiving space, and the two conductor-side seal carrier components are configured to be brought into contact with the first rail-shaped conductor and the second rail-shaped conductor.

2. The seal according to claim 1, wherein the two seal carrier components feature a snap-together mechanism which is mutually complementary, and the two seal carrier components are configured to be fastened together via the snap-together mechanism.

3. The seal according to claim 2, wherein the snap-together mechanism includes a latch plate with a locking catch on a first seal carrier component of the two seal carrier components and a latch sleeve with a detent on a second seal component of the two seal carrier components, with the latch sleeve configured to engage the locking catch.

4. The seal according to claim 1, wherein at least one circumferential channel is formed in the seal carrier, and the at least one circumferential channel is configured to receive an injection molding compound.

5. The seal according to claim 4, wherein the at least one circumferential channel extends perpendicular to a longitudinal extension direction of the first rail-shaped conductor and the second rail-shaped conductor, and the seal carrier includes a housing-side sealing element configured to seal the at least one circumferential channel on a side of the seal carrier up to the longitudinal extension direction of the first rail-shaped conductor and second rail-shaped conductor.

6. The seal according to claim 4, wherein the seal carrier includes a first circumferential channel formed along an outer circumferential surface of the seal carrier and a second circumferential channel formed along an inner circumferential surface of the seal carrier.

7. The seal according to claim 1, wherein a first seal carrier component of the two seal carrier components includes a strain relief feature formed on an inner side of the first seal carrier component, the inner side of the first seal carrier component faces the first receiving space and the second receiving space, the strain relief feature is configured to exert a pressing force onto a surface of at least one of the first rail-shaped conductor or the second rail-shaped conductor.

8. The seal according to claim 1, wherein the seal carrier is comprised of a plastic material that is at least one of harder or stiffer than the conductor-side sealing element.

9. The seal according to claim 1, wherein the seal carrier is comprised of a plastic material that is at least one of harder or stiffer than a housing-side sealing element.

10. The seal according to claim 1, further comprising a housing configured to house the seal carrier and the conductor-side sealing element

11. The seal according to claim 10, wherein the housing is configured to house a housing-side sealing element.

12. A Double-rail conductor assembly comprising:
a first rail-shaped conductor,
a second rail-shaped conductor, and
a seal according to claim 1,
wherein the two seal carrier components and the two conductor-side seal carrier components of the seal are brought together around the first rail-shaped conductor and the second rail-shaped conductor from a sideways direction with respect to a longitudinal extension direction of the first rail-shaped conductor and the second rail-shaped conductor which runs parallel to the first rail-shaped conductor.
